(19) United States
(12) Patent Application Publication
(10) Pub. No.: US 2016/0329596 A1
(43) Pub. Date: Nov. 10, 2016

(54) ELECTROCHEMICAL DEVICE

(71) Applicant: Vladimir Leonidovich TUMANOV, Moscow (RU)

(72) Inventors: Vladimir Leonidovich Tumanov, Moscow (RU); Gennadij Petrovich Fedotov, Moscow (RU); Yaroslav Andreevich Menshikov, Moscow (RU)

(21) Appl. No.: 15/028,048

(22) PCT Filed: Oct. 8, 2014
(86) PCT No.: PCT/RU2014/000757

§ 371 Date: Apr. 8, 2016

(30) Foreign Application Priority Data
Jan. 31, 2014 (RU) 2014103306

(51) Int. Cl. H01M 10/04; H01M 2/06; H01G 11/82; H01G 11/70; H01G 11/28; H01M 2/02; H01M 2/10

(52) U.S. Cl. CPC H01M 10/0468; H01M 2/024; H01M 2/06; H01M 2/1072; H01M 10/0431; H01G 11/70; H01G 11/28; H01G 11/82

(57) ABSTRACT

The utility model relates to electric engineering and more specifically to solid-state electrochemical current sources such, for example, as storage batteries and supercapacitor banks. The electrochemical device consists of shell components, a cathode current-collecting leadout, an anode current-collecting leadout, and a package assembly. The package assembly includes unit electrochemical cells. The unit electrochemical cells are composed of a laminating housing with through openings, cathode and anode current-collecting terminals, and an electrode assembly. The electrode assembly of each unit electrochemical cell is composed of two electrodes of opposite polarity disposed between the current-collecting terminals and coiled in a flat roll and two separators therebetween.

This utility model relates to electric engineering and more specifically to solid-state electrochemical current sources such, for example, as storage batteries and supercapacitor banks.

Known in the art is an electrochemical device comprising shell components, a cathode current-collecting leadout, an anode current-collecting leadout, and a package assembly including unit electrochemical cells composed of a laminating housing with through openings, cathode and anode current-collecting terminals, and an electrode assembly (cf., Patent RU 133976, Cl. H01M 10/00, published on Oct. 27, 2013). A disadvantage of the prior art device is the necessity in a rather sophisticated and expensive equipment for sequential assembly of a large number of electrodes and separators and another disadvantage of said device is low performance reliability due to highly probable short circuit which may be caused by a plurality of edges.

Therefore, it is an object of this utility model to obviate the aforesaid disadvantages. The herein proposed technical result is obtained by simplifying the construction of the electrochemical device while maintaining efficiency thereof. The claimed object and technical result are accomplished by providing an electrochemical device which comprises shell components, a cathode current-collecting leadout, an anode current-collecting leadout, and a package assembly including unit electrochemical cells composed of a laminating housing with through openings, cathode and anode current-collecting terminals, and an electrode assembly and in which, according to the invention, the electrode assembly of each unit electrochemical cell is composed of two electrodes of opposite polarity suitably disposed between the current-collecting terminals and coiled in a flat roll, said electrodes secured to current-collecting substrates, and two separators therebetween, wherein the current-collecting substrate of the electrode of one polarity is electrically coupled over one end face of the roll with one current-collecting terminal and the current-collecting substrate of the electrode of the opposite polarity is electrically coupled over the opposite side of the electrode roll with the other current-collecting terminal, with the length and width of the current-collecting terminals corresponding to the length and width of the electrode roll, whereas the thickness thereof is not less than the total thickness of the electrode substrate layers connected thereto. Π- or Λ-shaped grooves are preferably made in places where the current-collecting terminals of the unit electrochemical cells join the electrode substrates, said grooves being designed to receive preformed electrode substrates with cut-throughs each having a width of 1 to 10 mm and a depth from the substrate edges to the separator edges. The current-collecting terminals of each unit electrochemical cell preferably have pimples as high as or higher than the laminating housing thickness, wherein each pimple enters the through opening of the laminating housing and the pimple interior is filled with a ballast material in flush with the internal surface of the current-collecting terminal. The side walls of the laminating housing may have several square, rectangular, hexagonal, triangular or round openings, with the total area of such openings being 0.01 to 0.99 of the electrode roll area.

Now the invention will be described with reference to a specific embodiment thereof taken in conjunction with the accompanying drawings, in which:

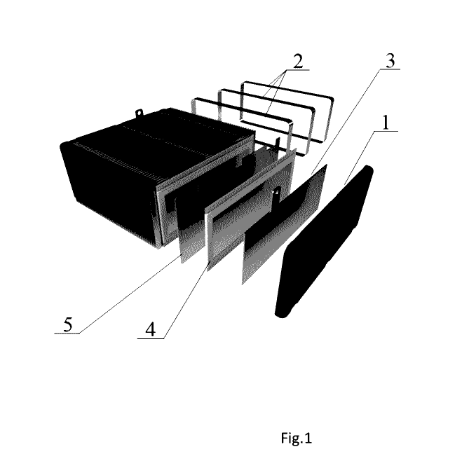

FIG. 1 illustrates basic components of the herein proposed electrochemical device;

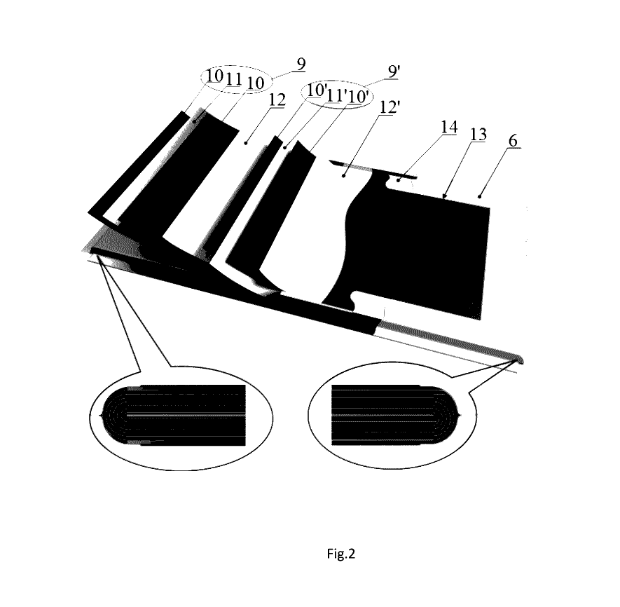

FIG. 2 illustrates the components of the unit electrode assembly cell;

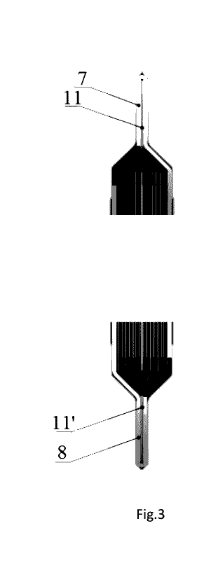

FIG. 3 illustrates the connection between the electrode substrate layers and current-collecting leadouts;

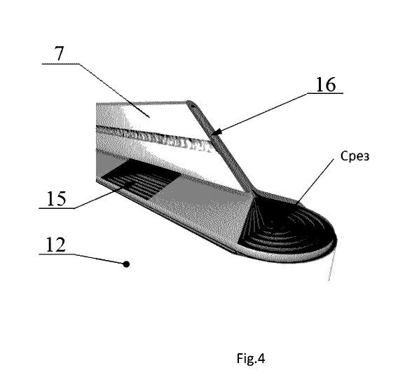

FIG. 4 is a general end view of the electrode roll with the cut-throughs and an angle cut;

FIG. 5 is ditto of FIG. 4, side view;

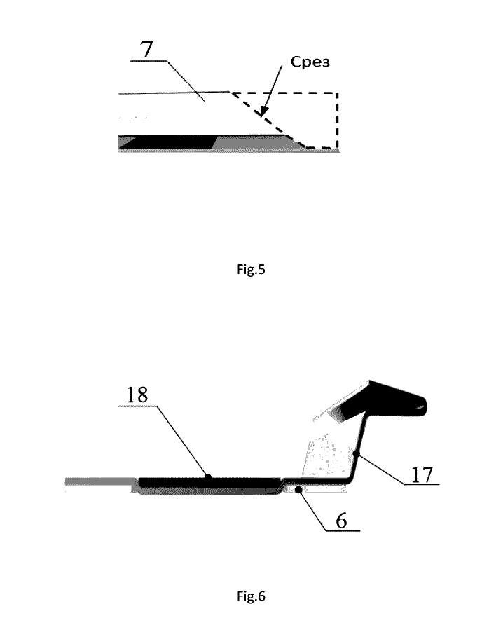

FIG. 6 is the current-collecting terminal design.

The herein proposed electrochemical device (FIG. 1) is composed of shell components: flanges 1 and tie elements 2 used to hold in place compressed electrochemical cells, cathode and anode current-collecting leadouts 3, and a package assembly composed of unit electrochemical cells 4 and current-conducting heat-removing plates 5. The unit electrochemical cells 4 are compressed between the flanges 1 by the tie elements 2 at a specific pressure of 0.05 to 2.0 MPa.

Each unit electrochemical cell 4 is enclosed in a laminating housing 6 with through openings and includes a cathode 7 and an anode 8 current-collecting terminals and an electrode assembly. The electrode assembly is composed of two electrodes 9 and 9′ of opposite polarity suitably disposed between the current-collecting terminals 7-8 and coiled in a flat roll, said electrodes representing an electrode material 10 (10′) with an active substance attached to a flexible current-collecting substrate 11 (11′).

The current-collecting substrate 11 (11′) of each electrode has a length free from the electrode material, said length being substantially in the form of a rim providing for switching between the substrate and the current-collecting terminals 7-8. The rim of the current-conducting substrate 11 of the electrode of one polarity protrudes above the roll end face on one side and electrically coupled with the current-collecting terminal 7 of the same polarity. The rim of the current-conducting substrate 11′ of the electrode of the opposite polarity protrudes above the roll end face on the opposite side and electrically coupled with the current-collecting terminal 8 of the opposite polarity.

The electrodes 9 and 9′ are separated by separators 12 and 12′ and together with the current-collecting terminals 7-8 are packed in the air-tight laminating housing 6 with electrolyte. The side walls of the housing 6 have through openings 13 via which interelement switching of the device is provided. The through openings 13 are connected along their periphery to the respective current-collecting terminals 7-8 with the aid of sealing inserts over a width equaling 3 to 10 thicknesses of the current-collecting terminals 7-8.

The length and width of the current-collecting terminals 7-8 correspond to the length and width of the electrode roll whereas the thickness thereof is not less than the total thickness of the layers of the electrode substrates 11-11′ connected thereto.

Cut-throughs 15 having a width of 1 to 10 mm and a depth from the substrate 11-11′ edges to the separator 12-12′ edges are made in the rims of the electrode substrates 11-11′ for more simple and fast fitting and for better impregnation of the electrode roll with electrolyte. Π- or Λ-shaped grooves 16 are preferably made in places where the current-collecting terminals 7-8 of the unit electrochemical cells join the electrode substrates 11-11′, said grooves being designed to receive preformed electrode substrates 11-11′ with the cut-throughs 15. The grooves 16 with the rims of the electrode substrates 11-11′ inserted therein are crimped and welded. The angles are cut (as shown in FIGS. 4 and 5) to protect the laminating housing 6 against internal damage.

The current-collecting terminals 7-8 are provided with pimples 17 as high as or higher than the laminating housing 6 thickness, wherein the pimple 17 enters the through opening 13. The pimples 17 are designed to compensate for the width of the laminating housing 6 and provide a uniform electrical contact area when the unit electrochemical cells are assembled in a device. The pimple 17 interior is filled with a ballast material in flush with the internal surface of the current-collecting terminals 7-8 to provide for uniform transmission of compression force from the current-collecting terminals 7-8 to the electrode roll.

The current-conducting and heat-removing plates 5 are suitably disposed between the unit electrochemical cells 4, said plates provided with cooling fins and used to remove heat (where necessary) and to connect circuits (if any) that balance electrical parameters of the unit electrochemical cells 4.

The side walls of the laminating housing 6 may additionally have several square, rectangular, hexagonal, triangular or round openings or openings of other forms, with the total area of such openings being 0.01 to 0.99 of the electrode area.

This utility model improves construction manufacturability, decreases cost and increases efficiency and reliability of operation of the electrochemical device.

1. An electrochemical device comprising:
shell components,
a cathode current-collecting leadout,
an anode current-collecting leadout,
a package assembly including unit electrochemical cells composed of a laminating housing with through openings, cathode and anode current-collecting terminals, and
an electrode assembly of each unit electrochemical cell including two electrodes of opposite polarity suitably disposed between the current-collecting terminals and coiled in a flat roll, said electrodes secured to current-collecting substrates, and two separators therebetween, wherein the current-collecting substrate of the electrode of one polarity is electrically coupled over one end face of the roll with one current-collecting terminal and the current-collecting substrate of the electrode of the opposite polarity is electrically coupled over the opposite side of the electrode roll with the other current-collecting terminal, with the length and width of the current-collecting terminals corresponding to the length and width of the electrode roll, whereas the thickness thereof is not less than the total thickness of the electrode substrate layers connected thereto.

2. The electrochemical device as claimed in claim 1, including Π- or Λ-shaped grooves made in places where the current-collecting terminals of the unit electrochemical cells join the electrode substrates, said grooves being designed to receive preformed electrode substrates with cut-throughs each having a width of 1 to 10 mm and a depth from the substrate edges to the separator edges.

3. The electrochemical device as claimed in claim 1, wherein the current-collecting terminals of each unit electrochemical cell have pimples being higher than the laminating housing thickness, wherein each pimple enters the through opening of the laminating housing and the pimple interior is filled with a ballast material in flush with the internal surface of the current-collecting terminal.

4. The electrochemical device as claimed in claim 1, wherein the side walls of the laminating housing have several square, rectangular, hexagonal, triangular or round openings, with the total area of such openings being 0.01 to 0.99 of the electrode roll area.
